(19) United States
(12) Patent Application Publication
(10) Pub. No.: US 2004/0148256 A1
(43) Pub. Date: Jul. 29, 2004

(54) Fraud detection within an electronic payment system

(75) Inventors: Arnold H. Bramnick, Boca Raton, FL (US); Mark A. Sehorne, Round Rock, TX (US); Brian Donald Watt, Austin, TX (US); Cornell G. Wright JR., Austin, TX (US)

Correspondence Address: Kelly K. Kordzik, 5400 Renaissance Tower, 1201 Elm Street, Dallas, TX, 75270, US

(73) Assignee: International Business Machines Corporation, Armonk, NY

(21) Appl. No.: 10/351,560

(22) Filed: Jan. 23, 2003

(51) Int. Cl. G06F 17/60

(52) U.S. Cl. 705/40

(57) ABSTRACT

In the processing of wholesale payments over the Internet, a condition manager within the buyer's banking institution will implement a condition manager that has an ability to contact a legacy fraud detection system, which monitors whether the proposed purchase is fraudulent or not. Such legacy fraud detection systems typically are looking for unusual purchasing patterns or other aberrations relative to this particular customer's past buying habits. This system can be implemented with respect to the use of electronic payments when products are purchased by customers over the Internet.

### TECHNICAL FIELD

The present invention relates in general to information handling networks for transacting electronic commerce, and in particular, for a system and method for detecting fraud in such electronic commerce (“e-commerce”) systems.

### BACKGROUND INFORMATION

Financial institutions, like companies worldwide, are steadily moving critical business functions to web-based infrastructures, which means that they must react to an ever-increasing number of users, technologies, and competition. A major challenge for banks and other financial institutions is setting up trustworthy, secure systems for automated, real-time payment order-services.

Currently, many companies transact e-business using public key infrastructure (“PKI”) technology. This is a system of digital certificates, certificate authorities and other registration authorities that verify and authenticate the validity of each party involved in an Internet transaction. PKIs, sometimes called trusted hierarchies, are still evolving; there are no universal standards for setting up a PKI, and PKI technology alone cannot solve many e-business (electronic business) issues.

One solution that has been developed gives banks and other financial institutions a single platform for all of their communications channels. This standards-based platform allows companies to build on current network technology investments as their businesses grow and change. One example is the trusted e-payment (electronic payment) initiative (“TePI”) developed by International Business Machine Corporation (“IBM”) as part of an overall IBM secure-payment solution, which is based on the “Eleanor” model developed by Identrus, L.L.C. The Eleanor model is discussed in more detail below. Identrus was formed in 1999 by a group of financial institutions to provide an infrastructure for global e-commerce. Identrus offers technology and services that support 100% trusted transactions. It enables management of business-to-business (B2B) e-commerce risk by providing a global framework for the provision of certificate authority services. The certified system created by Identrus has afforded merchants the ability to gather certified information from buyers, present that information to a bank, and have the bank arrange for payment of the obligation.

For example, in the Identrus model using the Eleanor protocol, the buyer can electronically sign a merchant's sales order from a web browser using a key card or smart card (via a card reader attached to the computer) and a PIN. That information, combined with the buyer's digital certificate is combined to comprise a “signed message.” Alternatively, a computer, with special hardware and a key/smart card inserted, can automatically sign sales orders or purchase orders without human physical action. The messages are forwarded via the merchant to the merchant's bank who arranges for payment from the buyer's bank.

The Eleanor protocol provides for a condition manager that manages external events. When the external events occur, payment can be made. Further, the Eleanor protocol provides for identification of invalidly “signed” messages. However, the Eleanor protocol does not provide for the condition of detection of unusual buying patterns (within properly signed messages) as is presently performed in the credit card industry by a mix of automatic and manual processes. In the credit card industry, there are long-standing processes to manually detect patterns that are unusual for cardholders. For example, a credit card transaction might be challenged if a bank is suddenly asked to authorize several multi-thousand dollar purchases in a single day.

Therefore, what is needed in the art is a system and method for detecting fraud in e-commerce transactions.

### SUMMARY OF THE INVENTION

The present invention addresses the foregoing need by providing an addition to the condition manager within the Eleanor protocol to allow for a credit card type unusual pattern detection process. This process can be invoked by the condition manager and can include detection of unusual patterns, or be expanded to include a requirement for manual confirmation of the payment request as a condition that must be fulfilled prior to actual payment. Additionally, buyer requested conditions and checks, outside of the e-payment system specification (e.g., the Eleanor protocol) could be implemented.

The process of the present invention can be made optional, and could be excluded at the request of the buyer. Alternatively, the buyer could set specific rules by which the process would detect “unusual patterns” from a group of rules offered by the process.

In one embodiment of the present invention, a method performs an electronic payment by receiving a request to authorize an electronic payment. In response to receipt of the request to authorize the electronic payment, information about the request is automatically sent to a fraud detection system. Upon receipt of a response from the fraud detection system, the electronic payment is automatically authorized to continue processing if the response is an affirmation that fraud has not been detected. If a response from the detection system indicates that there may be fraud involved with this electronic payment request, then continued processing of the electronic payment is denied.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of an e-payment process incorporating embodiments of the present invention;

FIG. 2 illustrates a message flow diagram of an embodiment of the present invention;

FIG. 3 illustrates a flow diagram of a process implemented within a condition manager in accordance with embodiments of the present invention; and

FIG. 4 illustrates a data processing system configured in accordance with an embodiment of the present invention.

### DETAILED DESCRIPTION

In the following description, numerous specific details are set forth such as specific fraud patterns or message protocols, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein like or similar elements are designated by the same reference numeral through the several views.

The present invention pertains to the purchase of goods and services over a network, such as the Internet. However, the present invention is also applicable to other transactions involving data networks that perform some of the steps within the inventive process and the other steps are performed manually. The present invention is also described with respect to an improvement within the Eleanor protocol used within the Identrus system, but is applicable to other protocols and e-payment systems.

The Eleanor protocol previously mentioned deals with payment initiation, as opposed to inter-bank messaging, clearing or settlement. (The Eleanor protocol is described in more detail in the following white paper: “Project Eleanor—A Global Payments Initiation System From Identrus, LLC,” Indentrus LLC, copyright 2002, pp. 1-18, which is hereby incorporated by reference herein.) It does not aim to replace existing paper or electronic clearing systems within and between other countries. The focus on Eleanor is on how business trading partners deal with each other, the types of risk in financing issues they face, and how banks can support them seamlessly and cost-effectively. The Eleanor protocol provides a new channel to initiate payments on existing back-office payment systems.

The Eleanor protocol implements conditional payment obligations, which allow a buyer to enter a transaction with the confidence that payment will only occur if agreements regarding, for example, quality, quantity or timeliness of delivery are met. Likewise, the seller can confidently proceed to fill an order knowing that value transfer will occur in due course. Any number of conditions can be placed on a payment obligation. The buyer's bank acts as the repository for conditions and an independent condition discharge party (“CDP”) can be used to monitor performance and notify completion, e.g., customs agents, logistics companies, or quality inspection firms.

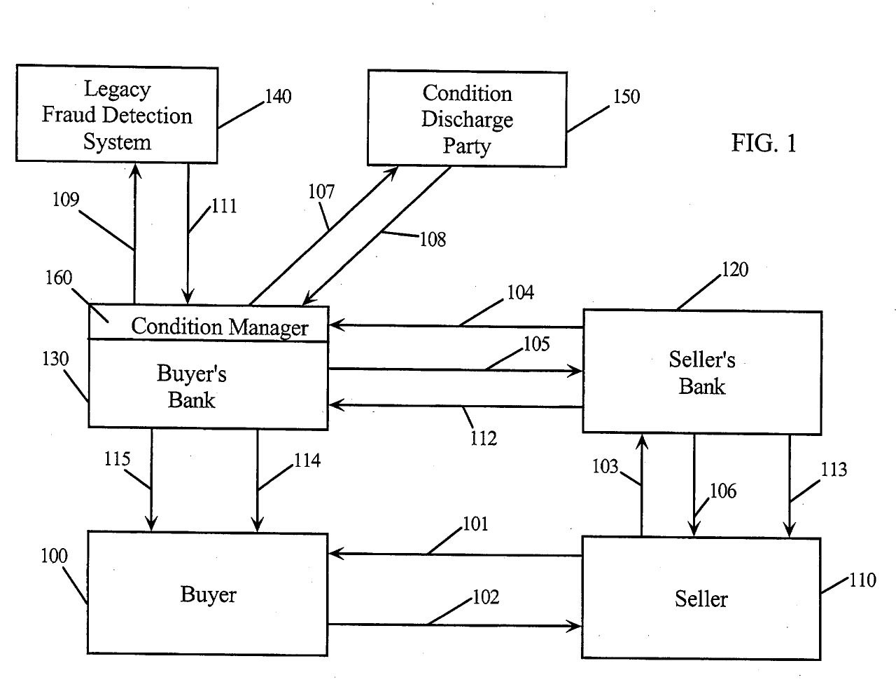

Referring to FIG. 1, a conditional payment obligation as satisfied under the Eleanor protocol is shown, along with an added embodiment in accordance with the present invention. In message 101, a buyer 100 and seller 110 agree on terms of purchase and sale and negotiate payment conditions. For example, if a retailer wishes to purchase product from a supplier, and the supplier does not want to deliver the product without being assured of payment, and the retailer is reluctant to pay for the product before it has been received, then the process of the present invention may be used to help the parties be assured that a transaction will be successfully completed to both of their satisfaction. When the buyer 100 is ready to purchase, the buyer 100 will send a conditional payment obligation 102 to the seller 110. In message 103, the seller 110 adds the bank account information with the purchase specifics and forwards this information to the seller's bank 120. In message 104, the seller's bank 120 validates the seller information, and then adds settlement instructions and forwards this information to the buyer's bank 130. In message 105, the buyer's bank 130 validates the buyer information including the authority of an employee to pay, and acknowledges the instructions with a message to the seller's bank 120. The message 106 is the seller's bank 120 relay of an acknowledgement back to the seller 110. Message 115 is the acknowledgement of the instructions to pay from the buyer's bank 130 to the buyer 100.

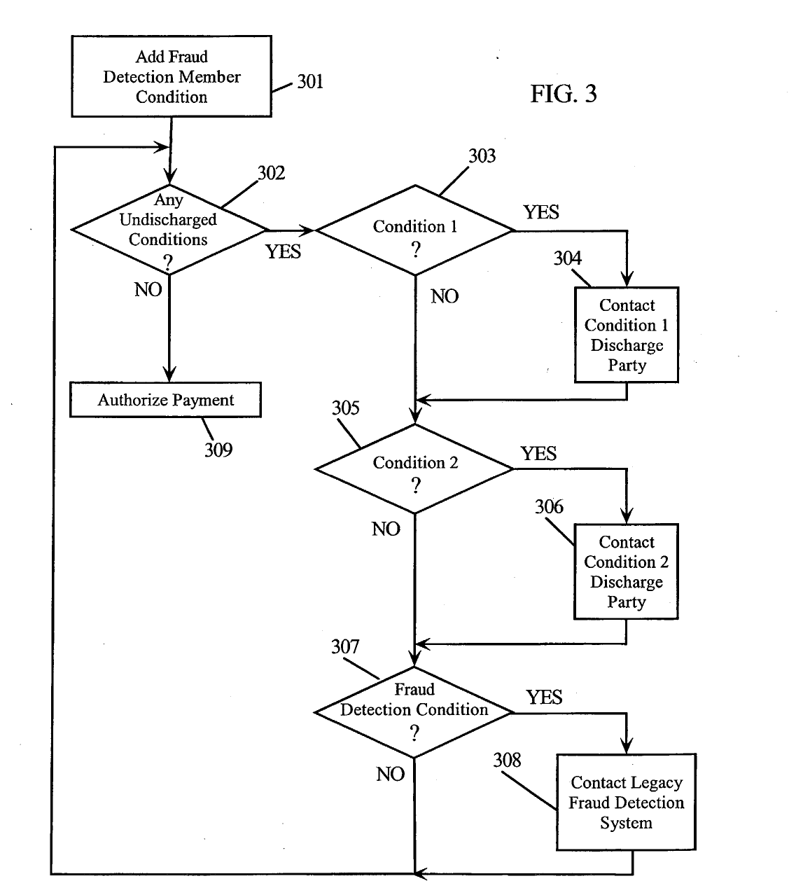

In the present Eleanor protocol, message flow 107 is the buyer's bank 130 notifying a condition discharge party 150 of any condition requirements. Message 108 is the condition discharge party 105 confirming condition compliance back to the buyer's bank 130. This process is further described below with respect to FIG. 3.

What present systems do not support is an ability to have the condition manager 160 of the buyer's bank 130 check with a legacy fraud detection system 140. Such a legacy fraud detection system 140 can be one of the known processes put in place by financial institutions, such as credit card companies, to monitor the purchasing patterns of their respective customers. Such legacy fraud detection systems 140 can be computerized or manual whereby an otherwise authorized purchase is analyzed to determine if it has the characteristics, or is one of a number of purchases that have characteristics, indicating that some sort of fraud is attempting to be performed by the buyer 100. Such an example might be where numerous high dollar purchases are attempted in a very short period of time, which is clearly abnormal in relation to the past buying habits of the credit card holder. Such an aberration in the buying habits of the particular credit card might indicate that the credit card has been stolen and is being used by the thief to make numerous high dollar purchases over the Internet.

Up to now, such a link between the condition manager 160 and legacy fraud detection systems 140 has not been possible. Condition discharge parties 150 are incapable of automatically performing such processes typically performed by legacy fraud detection systems 140. Condition discharge parties 150 are typically third parties involved in a normal purchase, such as a package carrier (e.g., Fedex, UPS, etc.).

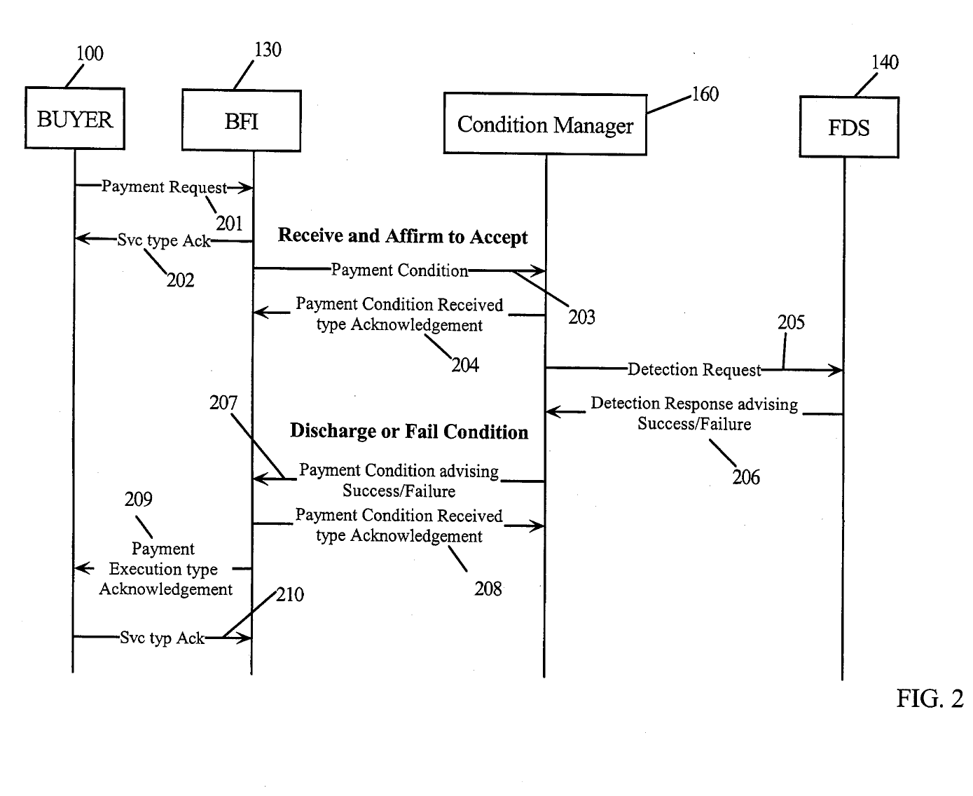

FIGS. 2-3 further describe the implementation of this added feature. Referring to FIG. 2, in message 201 a buyer 100 submits payment request message to the buyer's financial institution (“BFI”) 130 with or without subscriber conditions. In message 202, the BFI 130 verifies the message. If the verification fails, the BFI 130 responds to the buyer 100 with a service (Svc) type acknowledgement (Ack) advising “failure” and ceases further processing. If successful, the BFI 130 responds to the buyer 100 with a service type acknowledgement advising “success,” and continues processing. In message 203, the BFI 130 augments the payment request by attaching a member condition for fraud detection processing (in addition to the zero or more subscriber conditions attached by the buyer). See also step 301 in FIG. 3. Because the payment request is now a conditional payment request, the message is added to a condition registry (not shown) within the condition manager 160. In other words, the BFI 130 adds a condition to its internal copy of the payment request. Payment requests can have one or more conditions associated with them that must be discharged before the requested payment is made. This step adds a “member condition” that will be later processed by the condition manager 160. The term “member condition” refers to a condition type that is not described in the Eleanor specification, but is nevertheless accepted by the condition manager 160. The member condition is a mechanism to ensure that some or all of the payment requests receive fraud detection processing by making a generalized extension to the condition manager 160, rather than making specific fraud detection changes to the condition manager 160. Other mechanisms could be used; this one was selected because it provided generality while holding changes to the condition manger 160 to a reasonable minimum.

The condition manager 160, possibly in combination with a fraud detection system adapter (not shown), responds with message 204, which is a payment condition received type acknowledgement advising “success” to indicate that it will process this condition, and continues processing. The condition manager 160, possibly in combination with a fraud detection system adapter, then proceeds to perform fraud detection, which is further described in FIG. 3. In step 301, as noted previously, a fraud detection member condition has been added to provide for the checking with a legacy fraud detection system. In step 302, a determination is made whether there are any undischarged conditions. If yes, then the process proceeds to step 303 to determine if there is a first condition 1. If yes, then in step 304, the condition 1 discharge party will be contacted. Such a condition discharge party might be Fedex, which is handling the delivery of the product purchased. Once this is accomplished, the process proceeds to step 305 to determine if there is a second condition 2. If yes, then a condition 2 discharge party will be contacted in step 306. This may continue with any number of conditions, as is well known in the art. In step 307, a determination will be made whether there is a fraud detection condition that has been added. In this case, there has due to the added member condition, so the process proceeds to step 308 to contact the legacy fraud detection system 140 (see FIG. 1). Returning to FIG. 2, detection request message 205 will be sent to a fraud detection system 140. The fraud detection system 140, as described previously might involve human intervention, such as telephoning the buyer to determine if the payment request was submitted and appropriate. Once the fraud detection system 140 has made its determination, it will send a detection response 206 advising “success” indicating that the purchase is not fraudulent, or “failure” indicating that the purchase is a fraudulent purchase. Message 207 is a payment condition message to the BFI 130 advising either “success” to discharge the condition, or “failure” to fail the condition depending upon the outcome of the previous step from the fraud detection system 140. The BFI 130 verifies receipt of the message with message 208. If the verification fails, the BFI 130 responds to the condition manager 160 with a payment condition received type acknowledgement advising “failure,” and ceases further processing. If successful, the BFI 130 responds with a payment condition received type acknowledgement advising “success,” and continues processing. When all conditions have been successfully discharged (including the member condition just described), the payment request is sent to the back-end process for payment settlement whereby the funds are transferred using traditional fund transferring systems. If any of the conditions fail, such as a fraud was detected to this payment request, the message is not processed for settlement. This is also shown in FIG. 3 where there are no more undischarged conditions in step 302; payment is authorized in step 309. For successfully discharged payment requests, the BFI 130 sends an asynchronous payment execution type acknowledgement 209 advising “success” to the buyer 100 indicating that the payment request has been accepted for settlement. Upon receiving this message, the buyer 100 verifies the message. If the verification fails, the buyer 100 responds with a service type acknowledgment 210 advising “failure.” If successful, the buyer 100 responds to the BFI 130 with a service type acknowledgement advising “success.” Further processing of the payment will then occur, which is not detailed here since it is not relevant to a full description of the present invention.

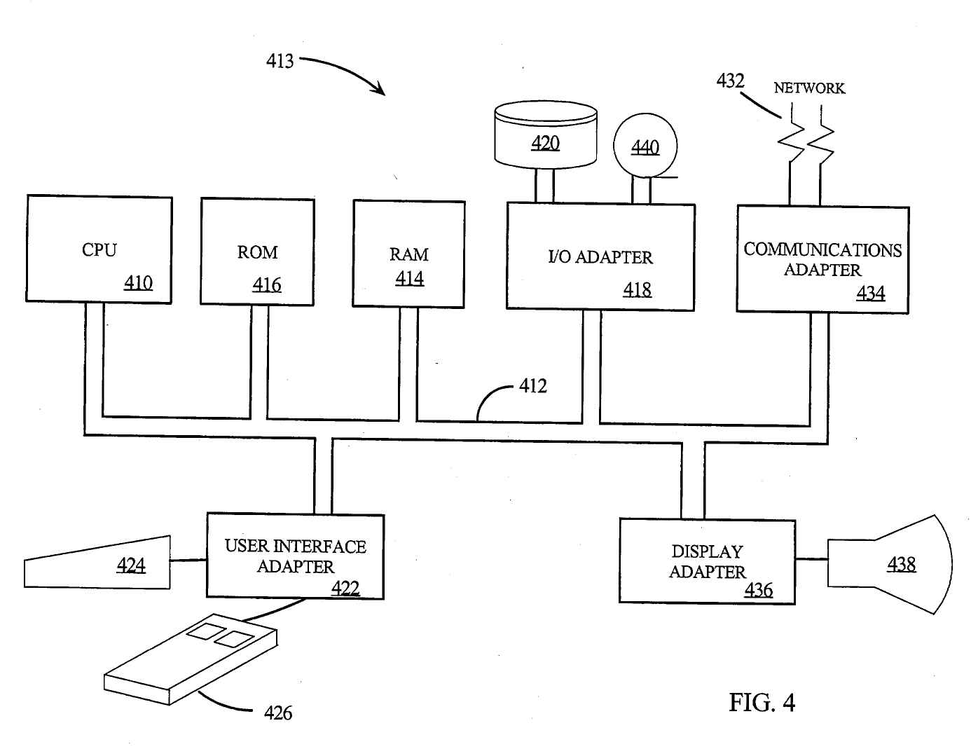

Referring to FIG. 4, a representative hardware environment for practicing the present invention is depicted in FIG. 4, which illustrates an exemplary hardware configuration of data processing system 413 in accordance with the subject invention having central processing unit (CPU) 410, such as a conventional microprocessor, and a number of other units interconnected via system bus 412. Data processing system 413 includes random access memory (RAM) 414, read only memory (ROM) 416, and input/output (I/O) adapter 418 for connecting peripheral devices such as disk units 420 and tape drives 440 to bus 412, user interface adapter 422 for connecting keyboard 424, mouse 426, and/or other user interface devices such as a touch screen device (not shown) to bus 412, communications adapter 434 for connecting data processing system 413 to a data processing network 432, and display adapter 436 for connecting bus 412 to display device 438. CPU 410 may include other circuitry not shown herein, which will include circuitry commonly found within a microprocessor, e.g., execution unit, bus interface unit, arithmetic logic unit, etc. CPU 410 may also reside on a single integrated circuit.

System 413 could be used in any or all of the systems shown in FIG. 1. The buyer may use system 413 to surf the Web and purchase goods from seller's 110 website. System 413 could be used by the banks 130, 120 to transfer funds. FDS 140 could use system 413 to check for possible fraud in the transaction.

Implementations of the invention include implementations as a computer system programmed to execute the method or methods described herein, and as a computer program product. According to the computer system implementation, sets of instructions for executing the method or methods may be resident in the random access memory 414 of one or more computer systems configured generally as described above. Until required by the computer system, the set of instructions may be stored as a computer program product in another computer memory, for example, in disk drive 420 (which may include a removable memory such as an optical disk or floppy disk for eventual use in the disk drive 420). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

What is claimed is:

1. A method for performing an electronic payment comprising the steps of:
receiving a request to authorize an electronic payment;
in response to receipt of the request to authorize the electronic payment, automatically sending information about the request to a fraud detection system;
upon receipt of a first electronic message from the fraud detection system, automatically authorizing continued processing of the electronic payment; and
upon receipt of a second electronic message from the fraud detection system, automatically denying continued processing of the electronic payment.

2. The method as recited in claim 1, wherein the electronic payment is an authorization to debit a financial account of a buyer of a good or service.

3. A computer program product adaptable for storage on a computer readable medium, the computer program product operable for performing an electronic payment, comprising the program steps of:
receiving a request to authorize an electronic payment;
in response to receipt of the request to authorize the electronic payment, sending information about the request to a fraud detection system;
upon receipt of a first message from the fraud detection system, authorizing continued processing of the electronic payment; and
upon receipt of a second message from the fraud detection system, denying continued processing of the electronic payment.

4. The computer program product as recited in claim 3, wherein the program steps are implemented within a condition manager operating under an Eleanor protocol.

5. The computer program product as recited in claim 3, wherein the sending step if performed if a fraud detection member condition has been added to the request.

6. The computer program product as recited in claim 3, wherein the sending step sends the information about the request to the fraud detection system over a network connection.

7. A data processing system comprising:
a processor;
a memory device;
an input device;
an output device;
circuitry operable for connecting the system to a network;
a bus communication system coupling the processor to the memory device, the input device, the output device, and the circuitry operable for connecting the system to the network; and
circuitry for receiving a request to debit a customer's financial account as a result of a proposed purchase by the customer;
circuitry for sending a message to a fraud detection system to evaluate whether the request is possibly fraudulent;
circuitry for receiving a reply from the fraud detection system, wherein the reply indicates whether the request should be approved or denied;
circuitry for continuing processing of the request if the reply indicates that the request should be approved; and
circuitry for terminating continued processing of the request if the reply indicates that the request should be denied.

8. The system as recited in claim 7, wherein the sending circuitry further comprises:
circuitry for determining if fraud detection is to be evaluated for requests pertaining to this customer.

9. The system as recited in claim 8, wherein the sending circuitry sends the fraud detection request through the circuitry operable for connecting the system to the network.

10. A system comprising:
means for receiving a request to debit a customer's financial account as a result of a proposed purchase by the customer;
means for sending a message to a fraud detection system to evaluate whether the request is possibly fraudulent;
means for receiving a reply from the fraud detection system, wherein the reply indicates whether the request should be approved or denied;
means for continuing processing of the request if the reply indicates that the request should be approved; and
means for terminating continued processing of the request if the reply indicates that the request should be denied.

11. The system as recited in claim 10, wherein the sending means further comprises:
means for determining if fraud detection is to be evaluated for requests pertaining to this customer.
